(19) United States
(12) Patent Application Publication
(10) Pub. No.: US 2015/0377635 A1
(43) Pub. Date: Dec. 31, 2015

(54) METHOD AND APPARATUS FOR DETERMINING A DROP-OFF AND A PICK-UP LOCATION BASED ON FITNESS GOALS

(71) Applicant: HERE Global B.V., Espoo (NL)

(72) Inventors: Jerome BEAUREPAIRE, Berlin (DE); Marko Tapio TUUKKANEN, Schlenzer (DE)

(21) Appl. No.: 14/317,971

(22) Filed: Jun. 27, 2014

(51) Int. Cl. G01C 21/34; A63B 24/00

(52) U.S. Cl. CPC G01C 21/34; A63B 24/0021

(57) ABSTRACT

An approach is provided for determining a drop-off location, a pick-up location, or a combination thereof at a certain time period based, at least in part, on user fitness targets, user preferences, or a combination thereof. The approach involves determining at least one user location associated with at least one user. The approach also involves determining fitness parameter information associated with the at least one user. The approach further involves causing, at least in part, a calculation of at least one drop-off location, at least one pick-up location, or a combination thereof with respect to the at least one user location based, at least in part, on the fitness parameter information. The approach also involves causing, at least in part, a configuration of at least one vehicle to travel to the at least one drop-off location, at least one pick-up location, or a combination thereof.

### BACKGROUND

Service providers and device manufacturers (e.g., wireless, cellular, etc.) are continually challenged to deliver value and convenience to consumers by, for example, providing compelling network services. One area of interest has been the development of mobile devices to improve the fitness of their users. By way of example, mobile devices are equipped with various sensors for monitoring the fitness activities of their users. However, such mobile devices are not linked with autonomous vehicles to assist the users in reaching their fitness targets. Accordingly, service providers and device manufacturers face significant technical challenges in synchronizing data between a mobile device associated with a user and a device associated with at least one autonomous vehicle to support a user in achieving their fitness goal.

### SOME EXAMPLE EMBODIMENTS

Therefore, there is a need for an approach for determining a drop-off location, a pick-up location, or a combination thereof at a certain time period based, at least in part, on user fitness targets, user preferences, or a combination thereof.

According to one embodiment, a method comprises determining at least one user location associated with at least one user. The method also comprises determining fitness parameter information associated with the at least one user. The method further comprises causing, at least in part, a calculation of at least one drop-off location, at least one pick-up location, or a combination thereof with respect to the at least one user location based, at least in part, the fitness parameter information. The method also comprises causing, at least in part, a configuration of at least one vehicle to travel to the at least one drop-off location, at least one pick-up location, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to determine at least one user location associated with at least one user. The apparatus is also caused to determine fitness parameter information associated with the at least one user. The apparatus is further caused to causing, at least in part, a calculation of at least one drop-off location, at least one pick-up location, or a combination thereof with respect to the at least one user location based, at least in part, the fitness parameter information. The apparatus is also caused to cause, at least in part, a configuration of at least one vehicle to travel to the at least one drop-off location, at least one pick-up location, or a combination thereof.

According to another embodiment, a computer-readable storage medium carries one or more sequences of one or more instructions which, when executed by one or more processors, cause, at least in part, an apparatus to determine at least one user location associated with at least one user. The apparatus is also caused to determine fitness parameter information associated with the at least one user. The apparatus is further caused to cause, at least in part, a calculation of at least one drop-off location, at least one pick-up location, or a combination thereof with respect to the at least one user location based, at least in part, the fitness parameter information. The apparatus is also caused to cause, at least in part, a configuration of at least one vehicle to travel to the at least one drop-off location, at least one pick-up location, or a combination thereof.

According to another embodiment, an apparatus comprises means for determining at least one user location associated with at least one user. The apparatus also comprises means for determining fitness parameter information associated with the at least one user. The apparatus further comprises means for causing, at least in part, a calculation of at least one drop-off location, at least one pick-up location, or a combination thereof with respect to the at least one user location based, at least in part, the fitness parameter information. The apparatus also comprises means for causing, at least in part, a configuration of at least one vehicle to travel to the at least one drop-off location, at least one pick-up location, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-9, 21-29, and 44-46.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining a drop-off location, a pick-up location, or a combination thereof at a certain time period based, at least in part, on user fitness targets, user preferences, or a combination thereof, according to one embodiment;

FIG. 2 is a diagram of the components of the configuration platform 109, according to one embodiment;

FIG. 3 is a flowchart of a process for configuring at least one vehicle to travel to the at least one drop-off location and/or at least one pick-up location based, at least in part, on user location and/or fitness parameter information, according to one embodiment;

FIG. 4 is a flowchart of a process for causing a recalculation of routes and vehicle synchronization based, at least in part, on the monitoring of health sensor information and/or fitness performance information, according to one embodiment;

FIG. 5 is a flowchart of a process for causing a recommendation of at least one fitness activity based, at least in part, on fitness parameter information of at least one user, according to one embodiment;

FIG. 6 is a flowchart of a process for determining contextual information associated with one or more users, and the nearby environment associated with the user location, according to one embodiment;

FIG. 7 is a user interface diagram that represents a fitness application that tracks training activity for at least one user, according to one example embodiment;

FIG. 8A is a user interface diagram that represents a scenario wherein at least one vehicle recommends at least one drop-off location to at least one user, according to one example embodiment;

FIG. 8B is a user interface diagram that represents a scenario wherein at least one vehicle recommends at least one pick-up location to at least one user, according to one example embodiment;

FIG. 9 A-B are user interface diagrams that represents a scenario wherein pedestrian routes are optimized with the vehicle routes to support going faster to the at least one destination, according to one example embodiment;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal (e.g., handset) that can be used to implement an embodiment of the invention.

### DESCRIPTION OF SOME EMBODIMENTS

Examples of a method, apparatus, and computer program for determining a drop-off location, a pick-up location, or a combination thereof at a certain time period based, at least in part, on user fitness targets, user preferences, or a combination thereof are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

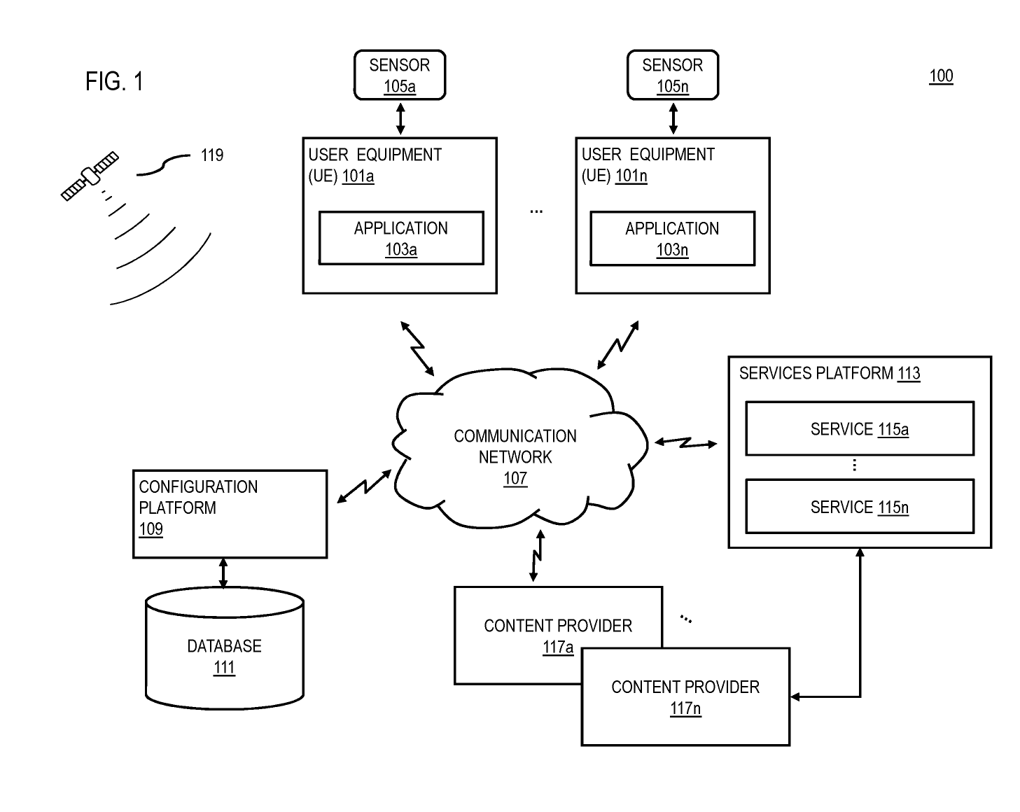

FIG. 1 is a diagram of a system capable of determining a drop-off location, a pick-up location, or a combination thereof at a certain time period based, at least in part, on user fitness targets, user preferences, or a combination thereof, according to one embodiment. As discussed, one or more mobile devices associated with a user are not connected with the autonomous vehicles henceforth limiting the potential of autonomous vehicles in assisting one or more users in reaching their fitness targets.

To address this problem, a system 100 of FIG. 1 introduces the capability to allow users with autonomous vehicles to reach their daily fitness goals through the support of their autonomous vehicles by being dropped-off or picked-up at locations targeted for this purpose. In one scenario, if a user has indicated a goal of walking 8000 steps per day, the system 100 may detect the number of steps walked by the user during the day, and may determine a pick-up location to enable the user achieve the fitness goal of walking 8000 steps per day. For example, the system 100 may suggest a pick-up location 1 km away from work upon detecting that a user has taken 6500 steps during the day. In another scenario, the system 100 may process the calendar information of at least one user, and may determine that the user has a meeting in the evening whereupon the system 100 may adjust the drop-off location for the user in the morning. For example, the vehicle may stop 1 km before arriving at the user's workplace. In a further scenario, a user may set personal health targets, or a target weight. The configuration platform 109 may convert such targets to an exercise regimen, for example, walking, running, cycling etc. Subsequently, a vehicle may optimize a driving route and a pick-up location. The locations may be optimized by distance, map geometry, or a combination thereof.

In one embodiment, the system 100 may consider the health of a user while determining a drop-off location, a pick-up location, or a combination thereof. In one scenario, sensors associated with a vehicle may detect at least one user's (e.g. drivers, passengers) weight, pulse, body temperature, calories, etc. In one scenario, the sensors associated with a vehicle may also predict an upcoming seizure or a heart attack for at least one user. Then, the system 100 may determine a drop-off location, a pick-up location, or a combination thereof based, at least in part, on the detected health condition of the user. In another embodiment, the system 100 may detect and identify one or more users via one or more sensors. Such sensors may gather details on one or more users when the users sit in the vehicle. In one scenario, the physical information of one or more users may be used to determine and activate a fitness activity (e.g. walking, running etc.). In addition, such physical information may be used as an additional measure in defining the level of fitness activity.

In one embodiment, the system 100 may consider the weather information while determining at least one drop-off location, at least one pick-up location, a timing for a drop-off, a timing for a pick-up, or a combination thereof. In one scenario, the system 100 may recommend fitness activity based, at least in part, on the temperature during the day. In another scenario, if the weather is rainy, the system 100 may recalculate the route by reducing some parts of the route, and may suggest some indoor paths. The system 100 may also recommend one or more users to take stairs as opposed to an elevator or an escalator. Further, the system 100 may also advice a user to carry an umbrella or a raincoat. In another embodiment, the system 100 may monitor the traffic conditions in real-time to assist one or more users to eliminate unnecessary stops and reach optimal fuel-efficiency. In addition, informed travelers may also be able to avoid congestion by taking alternate routes (e.g. pedestrian route) or recalculating their travel plan thereby making their trip more eco-friendly. In one scenario, if a user is stuck in traffic, the system 100 may suggest travelling the last kilometer on foot, the user may be closer to his/her fitness objectives and may actually arrive faster at work. In another scenario, the system 100 may search for point of interest (POIs) or “proper” drop off locations while looking for one or more drop-off locations around a destination, for example, if the system 100 detects three drop-off locations around a destination, the drop-off location 20 meters from a restaurant (POI) may be ranked higher as compared to the other two because it may be easier to find a parking location in front of a restaurant.

In one embodiment, the system 100 may consider a user's mood while determining at least one drop-off location, at least one pick-up location, or a combination thereof. In one scenario, a user may set personal targets and preferences. This may include optimizing a pick-up location to match user's location at an upcoming event. For example, a user may run at a certain speed and may maintain a steady pulse for certain distance based on the current health data and records. The pick-up location may be optimized accordingly. In another embodiment, the system 100 may detect one or more objects carried by a user (e.g., luggage, bags, laptop etc.) to recommend a fitness activity, a drop-off location, a pick-up location, or a combination thereof. In another embodiment, the system 100 may detect multiple users in a vehicle. Then, the system 100 may recommend a fitness activity, a drop-off location, a pick-up location, or a combination thereof based, at least in part, on the average of fitness condition of the users, their fitness targets, or a combination thereof. In such manner, the system 100 utilizes the cloud based services which synchronizes all the data between the user, the wearable devices and the autonomous vehicle to assist one or more users in performing fitness activities.

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.). In one embodiment, the one or more vehicles may have cellular or Wi-Fi connection either through the inbuilt communication equipment or from the UE 101 associated with the vehicles. The applications 103 may assist in conveying sensor information via the communication network 107.

By way of example, the applications 103 may be any type of application that is executable at the UE 101, such as location-based service applications, content provisioning services, camera/imaging application, media player applications, social networking applications, navigation applications, mapping application, calendar applications, and the like. In one embodiment, one of the applications 103 at the UE 101 may act as a client for the configuration platform 109 and may perform one or more functions associated with the functions of the configuration platform 109 by interacting with the configuration platform 109 over the communication network 107.

By way of example, the sensors 105 may be any type of sensor. In certain embodiments, the sensors 105 may include, for example, a global positioning sensor for gathering location data (e.g., GPS), a health sensor (e.g. heart-rate monitor, blood pressure monitor, calories sensors etc.), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, and the like. In one scenario, the sensors 105 may include, light sensors, oriental sensors augmented with height sensor and acceleration sensor, tilt sensors to detect the degree of incline or decline of the vehicle along a path of travel, moisture sensors, pressure sensors, audio sensors (e.g., microphone), etc. In one example embodiment, the UE 101 may include GPS receivers to obtain geographic coordinates from satellites 119 for determining current location and time associated with the UE 101. In another example embodiment, the sensors 105 may detect weather data, passenger status (e.g., the number of passengers actively seated), etc. Further, sensors about the perimeter of the vehicle may detect the relative distance of the vehicle from sidewalks, lane or roadways, the presence of other vehicles, trees, benches, water, potholes and any other objects, or a combination thereof. Still further, the one or more sensors may provide in-vehicle navigation services, wherein one or more location based services may be provided to the at least one UE 101 associated with the at least one user of the vehicle and/or at least one other UE 101 associated with the at least one vehicle.

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the configuration platform 109 may be a platform with multiple interconnected components. The configuration platform 109 may include multiple servers, intelligent networking devices, computing devices, components and corresponding software for determining a drop-off location, a pick-up location, or a combination thereof at a certain time period based, at least in part, on user fitness targets, user preferences, or a combination thereof.

In one embodiment, the configuration platform 109 may determine at least one user location associated with at least one user. In one scenario, the configuration platform 109 may receive a fitness targets from at least one user. Then, the configuration platform 109 may determine current location and time information for a UE 101 via GPS receivers associated a UE 101 from satellites 119. In another embodiment, the configuration platform 109 may determine a fitness parameter information associated with the at least one user. In one scenario, the configuration platform 109 may monitor the health condition for at least one user during travel from the current location to the at least one drop-off location, at least one pick-up location, or a combination thereof. In another scenario, the configuration platform 109 may monitor the health condition for at least one user during fitness activities.

In one embodiment, the configuration platform 109 may calculate at least one drop-off location, at least one pick-up location, or a combination thereof with respect to the at least one user location based, at least in part, on the fitness parameter information. In one scenario, the configuration platform 109 may monitor the distance travelled, the health condition, or a combination thereof of at least one user. Next, the configuration platform 109 may cause a communication between at least one device associated with at least one user and at least one device associated with at least one vehicle. Then, the configuration platform 109 may cause a transmission of the monitored information to the at least one device associated with at least one vehicle. Subsequently, the configuration platform 109 may determine at least one drop-off location, at least one pick-up location, a timing for a drop-off, a timing for a pick-up, or a combination thereof based, at least in part, on the monitored information.

In one embodiment, the configuration platform 109 may cause a configuration of at least one vehicle to travel to the at least one drop-off location, at least one pick-up location, or a combination thereof at at least one target time. In one scenario, the configuration platform 109 may cause an optimization of routing information to at least one drop-off location, at least one pick-up location, or a combination thereof based, at least in part, on synchronization of data between a device associated with at least one user, a device associated with at least one vehicle, or a combination thereof.

In one embodiment, the configuration platform 109 may create the database 111 to store user profile information, user health information, user preference information, calendar information, traffic information, weather information or a combination thereof. The information may be any multiple types of information that can provide means for aiding in the content provisioning and sharing process.

The services platform 113 may include any type of service. By way of example, the services platform 113 may include health information provisioning services, mapping services, navigation services, travel planning services, location based services, social networking services, content (e.g., audio, video, images, etc.) provisioning services, application services, storage services, contextual information determination services, information (e.g., weather, news, etc.) based services, etc. In one embodiment, the services platform 113 may interact with the UE 101, the configuration platform 109 and the content providers 117 to supplement or aid in the processing of the content information to determine at least one drop-off location, at least one pick-up location, or a combination thereof.

By way of example, the services 115 may be an online service that reflects interests and/or activities of users. In one scenario, the services 115 provide representations of each user (e.g., a profile), his/her social links, and a variety of additional information. The services 115 allow users to share location information, activities information, contextual information, historical user information and interests within their individual networks, and provides for data portability.

The content providers 117 may provide content to the UE 101, the configuration platform 109, and the services 115 of the services platform 113. The content provided may be any type of content, such as textual content, audio content, video content, image content, etc. In one embodiment, the content providers 117 may provide content that may supplement content of the applications 103, the sensors 105, or a combination thereof. By way of example, the content providers 117 may provide content that may aid in determining at least one drop-off location, at least one pick-up location, or a combination thereof. In one embodiment, the content providers 117 may also store content associated with the UE 101, the configuration platform 109, and the services 115 of the services platform 113. In another embodiment, the content providers 117 may manage access to a central repository of data, and offer a consistent, standard interface to data.

By way of example, the UE 101, the configuration platform 109, the services platform 113, and the content providers 117 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

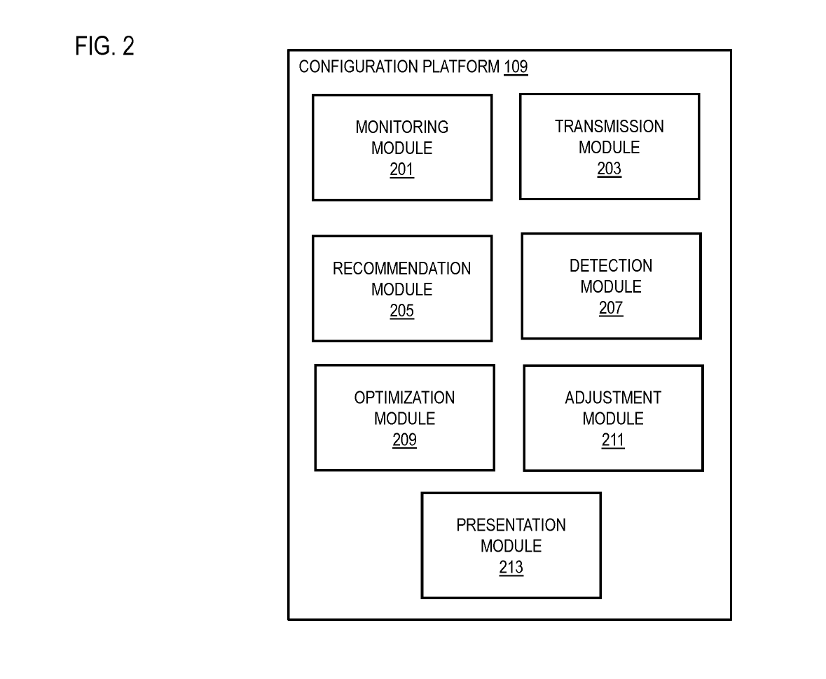

FIG. 2 is a diagram of the components of the configuration platform 109, according to one embodiment. By way of example, the configuration platform 109 includes one or more components for determining a drop-off location, a pick-up location, or a combination thereof at a certain time period based, at least in part, on user fitness targets, user preferences, or a combination thereof. It is contemplated that the functions of these components may be combined in one or more components or performed by other components of equivalent functionality. In this embodiment, the configuration platform 109 includes a monitoring module 201, a transmission module 203, a recommendation module 205, a detection module 207, an optimization module 209, an adjustment module 211 and a presentation module 213.

In one embodiment, the monitoring module 201 may monitor the distance travelled by at least one user, the health condition of at least one user, or a combination thereof in real-time during a travel to at least one pick-up location. In another embodiment, the monitoring module 201 may cause a real-time monitoring of the nearby environment, the traffic conditions, the weather conditions, the calendar information, or a combination thereof. In one scenario, the monitoring module 201 may cause a real time monitoring of the user activities. Then, the monitoring module 201 may co-ordinate with the recommendation module 205 to recommend an adjustment in the pick-up location in real time. For example, if a user has been running faster than expected or certain health condition is detected, then the pick-up location may be adjusted at a closer location.

In one embodiment, the transmission module 203 may cause a transmission of the monitored information from at least one device associated with at least one user to the at least one device associated with at least one vehicle. In another embodiment, the transmission module 203 may assist the configuration platform 109 in synchronizing data between at least one device associated with at least one user and at least one device associated with at least one vehicle.

In one embodiment, the recommendation module 205 may cause a recommendation of at least one drop-off location, at least one pick-up location, or a combination thereof based, at least in part, on user preference information, weather condition, traffic condition, calendar information, or a combination thereof. In another embodiment, the recommendation module 205 may cause a recommendation of at least one drop-off location, at least one pick-up location, or a combination thereof based, at least in part, on a pre-defined criteria. In a further embodiment, the recommendation module 205 may recommend at least one fitness activity for a user to engage in during travel between the at least one user location and the at least one pick-up location based, at least in part, on the health condition of at least one user.

In one embodiment, the detection module 207 may detect one or more objects carried by a user. In one scenario, the detection module 207 may detect that a user is carrying a suitcase, whereupon the recommendation module 205 may recommend a suitable activity (e.g. walking) In another embodiment, the detection module may detect multiple passengers in the vehicle. The detection module 207 may assist the optimization module 209 to optimize the pick-up location, the drop-off location, or a combination thereof based, at least in part, on the weighted average of the health condition of one or more passengers (e.g. health information of the weakest passenger).

In one embodiment, the optimization module 209 may cause an optimization of routing information to at least one drop-off location, at least one pick-up location, or a combination thereof based, at least in part, on synchronization of data between a device associated with at least one user, a device associated with at least one vehicle, or a combination thereof. In another embodiment, the optimization module 209 may optimize at least one pick-up location for at least one user based, at least in part, on the pace maintained by at least one user, the pulse rate, or a combination thereof.

In one embodiment, the adjustment module 211 may cause a recalculation of at least one pick-up location, the fitness targets, or a combination thereof based, at least in part, on real-time monitoring of the health condition of at least one user, the nearby environment, the calendar information, weather condition, traffic condition, or a combination thereof.

In one embodiment, the presentation module 213 obtains a set of summary statistics from other modules, and continues with providing presentation of relevant contents to the at least one device. In another embodiment, the presentation module 213 may cause a presentation of one or more travel lanes, one or more pedestrian lanes, one or more bicycling lanes, one or more public transport lanes, one or more restricted lanes, or a combination thereof in at least one route segment. In a further embodiment, the presentation module 213 may cause an alert message regarding the at least one health condition of at least one user.

The above presented modules and components of the configuration platform 109 can be implemented in hardware, firmware, software, or a combination thereof. Though depicted as a separate entity in FIG. 1, it is contemplated that the configuration platform 109 may be implemented for direct operation by respective UE 101. As such, the configuration platform 109 may generate direct signal inputs by way of the operating system of the UE 101 for interacting with the applications 103. In another embodiment, one or more of the modules 201-213 may be implemented for operation by respective UEs, as a configuration platform 109. Still further, the configuration platform 109 may be integrated for direct operation with the services 115, such as in the form of a widget or applet, in accordance with an information and/or subscriber sharing arrangement. The various executions presented herein contemplate any and all arrangements and models.

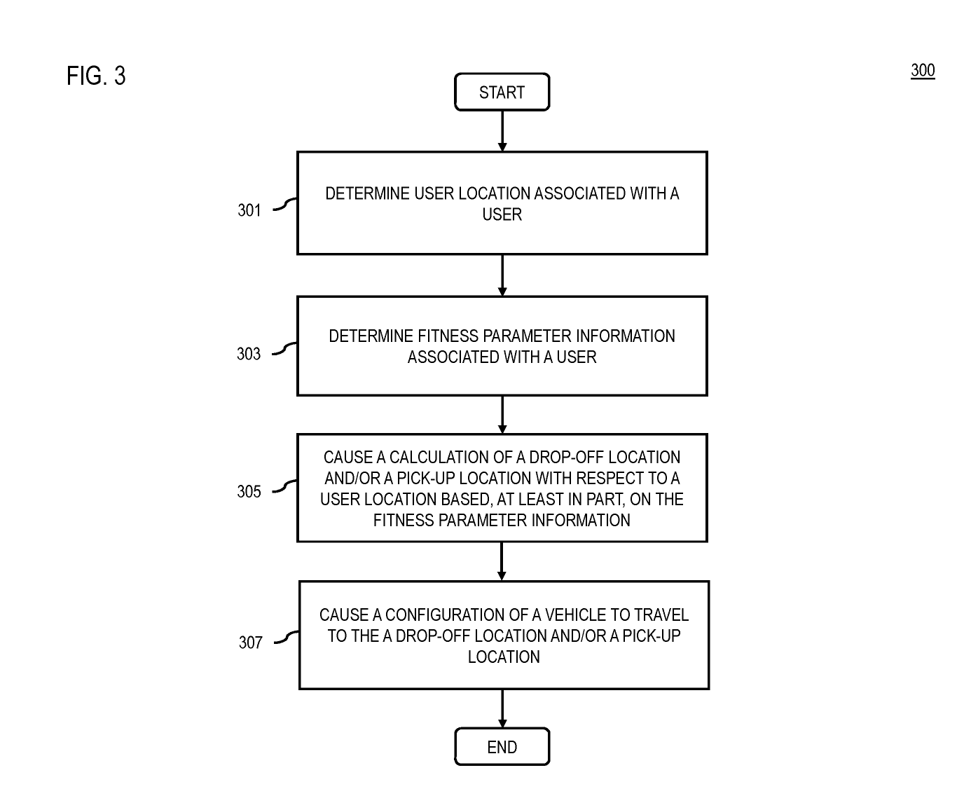

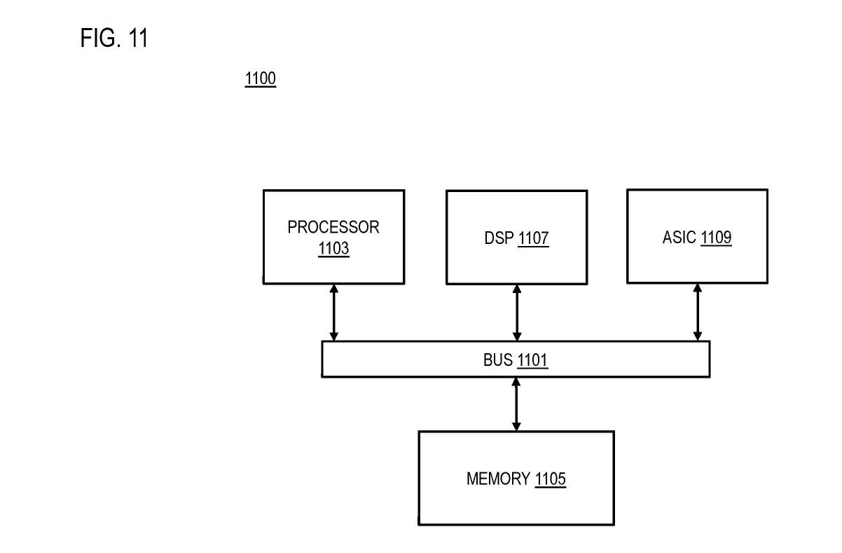

FIG. 3 is a flowchart of a process for configuring at least one vehicle to travel to the at least one drop-off location and/or at least one pick-up location based, at least in part, on user location and/or fitness parameter information, according to one embodiment. In one embodiment, the configuration platform 109 performs the process 300 and is implemented in, for instance, a chip set including a processor and a memory as shown in FIG. 11.

In step 301, the configuration platform 109 may determine at least one user location associated with at least one user. In one scenario, the configuration platform 109 may determine current user location via one or more sensor 105 of the UE 101 associated with at least one user. Then, the configuration platform 109 may optimize the pick-up location based on the current user location.

In step 303, the configuration platform 109 may determine a fitness parameter information associated with the at least one user. In one embodiment, the fitness parameter information includes personal fitness goals. The personal fitness goals may be set by a user per their preference. In one scenario, the configuration platform 109 may determine a drop-off and/or a pick-up location based on personal fitness goal of a user. In another scenario, the configuration platform 109 may present a user with alternative pick-up locations and/or drop-off location. The presentation may include the advantages of selecting a pick-up location and/or a drop-off location, for example, one pick-up location may be hilly but may burn more calories, whereas the other pick-up location may be flat and simple but may be longer etc. The users may select a pick-up location as per their preference.

In step 305, the configuration platform 109 may cause, at least in part, a calculation of at least one drop-off location, at least one pick-up location, or a combination thereof with respect to the at least one user location based, at least in part, on the fitness parameter information. In one scenario, the configuration platform 109 may detect the health condition of a user. Then, the configuration platform 109 may adjust the drop-off and/or the pick-up location based on the health condition of a user. For example, a user has arthritis and is not able to walk on rocky surfaces. The configuration platform 109 may recalculate a pedestrian route whereby the user gets to walk on a smooth surface. In another scenario, the configuration platform 109 may give new health challenges to a user based on their fitness parameter information, for example, a user may be provided with a pick-up location in a hilly area.

In step 307, the configuration platform 109 may cause, at least in part, a configuration of at least one vehicle to travel to the at least one drop-off location, at least one pick-up location, or a combination thereof. In one embodiment, the at least one vehicle is an autonomous vehicle, and wherein the at least one user location includes, at least in part, at least one current location, at least one destination location, or a combination thereof. In such manner, the configuration platform 109 may dynamically determine a drop-off location, a pick-up location, or a combination thereof at a particular time period based on the health condition of a user. In one embodiment, the configuration platform 109 may calculate an estimated total time for at least one training activity for at least one user. The configuration platform 109 may determine a pick-up target time for at least one user based on the travel time information. In another embodiment, the configuration platform 109 may process calendar information of at least one user to determine at least one potential time conflict with at least one training activity. Then, the configuration platform 109 may update the target time for a pick-up and/or a drop-off based on the conflict determination.

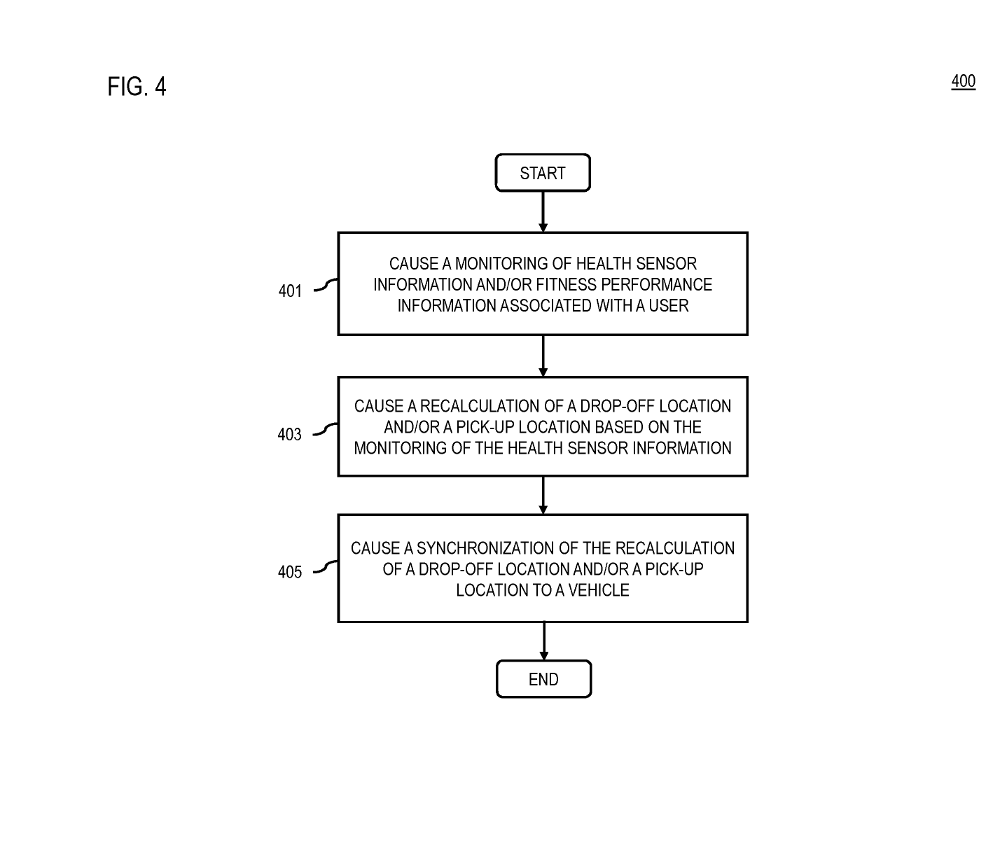

FIG. 4 is a flowchart of a process for causing a recalculation of routes and vehicle synchronization based, at least in part, on the monitoring of health sensor information and/or fitness performance information, according to one embodiment. In one embodiment, the configuration platform 109 performs the process 400 and is implemented in, for instance, a chip set including a processor and a memory as shown in FIG. 11.

In step 401, the configuration platform 109 may cause a monitoring of health sensor information, fitness performance information, or a combination thereof associated with the at least one user during travel by the at least one user from the at least one user location to the at least one drop-off location, the at least one pick-up location, or a combination thereof. In one scenario, the configuration platform 109 may suggest one or more pedestrian routes based, at least in part, on pollution levels. This strategy may enhance one or more users target to remain healthy.

In step 403, the configuration platform 109 may cause a recalculation of the at least one drop-off location, the at least one pick-up location, or a combination thereof based, at least in part, on the monitoring of the health sensor information. In one scenario, the configuration platform 109 may cause an adjustment in at least one pick-up location, the fitness targets, or a combination thereof based, at least in part, on real-time monitoring of the health condition of at least one user, the nearby environment, the calendar information, or a combination thereof. In one scenario, the configuration platform 109 may determine the agenda of the user by processing his/her calendar information. Then, the configuration platform 109 may recommend a fitness activity based on the calendar information. For example, a user may be recommended to walk 500 meter instead of 1 km because the user has to attend a meeting shortly thereafter.

In step 405, the configuration platform 109 may cause a synchronization of the recalculation of the at least one drop-off location, the at least one pick-up location, or a combination thereof to the at least one vehicle. In one example embodiment, the configuration platform 109 may adjust a pick-up location for a user upon detecting that a user is injured and is unable to continue further with his/her fitness activity. Then, the configuration platform 109 may set a pick-up location in a nearby area. Subsequently, the configuration platform 109 may synchronize the altered information to a vehicle, whereupon the vehicle may pick-up the user at a newly designated area at a newly set time.

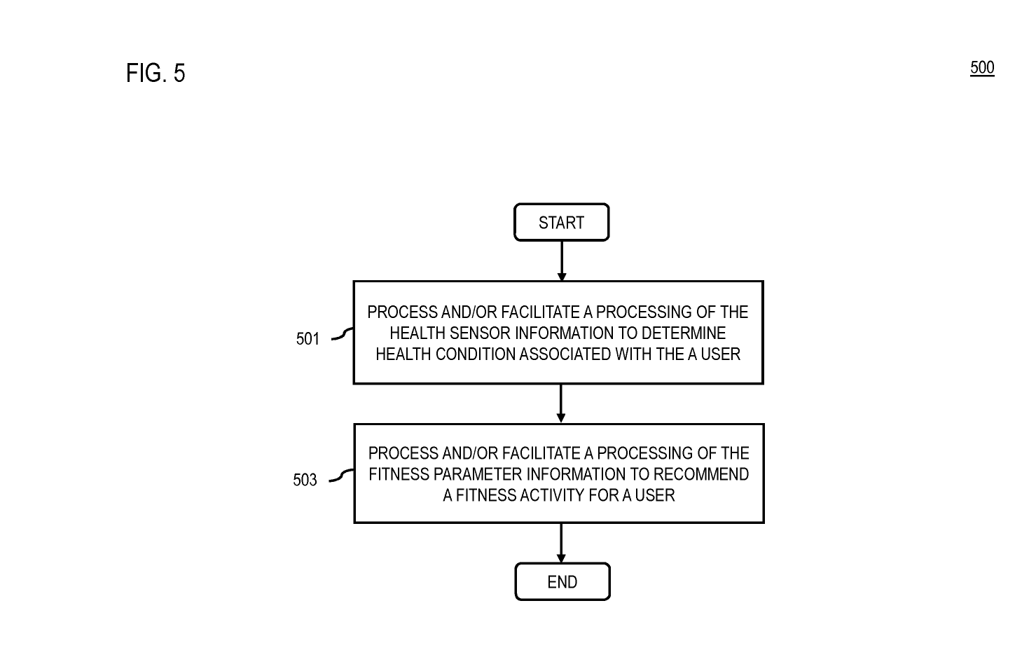

FIG. 5 is a flowchart of a process for causing a recommendation of at least one fitness activity based, at least in part, on fitness parameter information of at least one user, according to one embodiment. In one embodiment, the configuration platform 109 performs the process 500 and is implemented in, for instance, a chip set including a processor and a memory as shown in FIG. 11.

In step 501, the configuration platform 109 may process and/or facilitate a processing of the health sensor information to determine at least one health condition associated with the at least one user. In one embodiment, the configuration platform 109 may cause an overriding of the at least one drop-off location, the at least one pick-up location, or a combination thereof. In another embodiment, the configuration platform 109 may cause a presentation of at least one alert message regarding the at least one health condition. In a further embodiment, the configuration platform 109 may cause a directing of the at least one vehicle to at least one current location of the at least one user to collect additional sensor information, to deliver one or more supplies, to request user interaction with the at least one vehicle, or a combination thereof. In another embodiment, the configuration platform 109 may cause a collection of additional health sensor information by one or more sensors of the at least one vehicle.

In step 503, the configuration platform 109 may process and/or facilitate a processing of the fitness parameter information to recommend at least one fitness activity for the user to engage in during travel between the at least one user location and the at least one drop-off location, the at least one pick-up location, or a combination thereof. In one embodiment, the at least one fitness activity includes, at least in part, a walking activity, a running activity, a bicycling activity, a swimming activity, or a combination thereof. In another embodiment, the configuration platform 109 may cause an interruption of a fitness activity based, at least in part, on health condition of at least one user, weather condition, calendar information, or a combination thereof. In one scenario, the configuration platform 109 may interrupt a user activity by coming to pick-up the user upon detecting that a user has unsteady pulse or otherwise is suffering from health issues. In one scenario, the configuration platform 109 may instruct the at least one vehicle to recommend a user to enter the vehicle earlier, this process may involve rejecting user requests for pick-up at a latter timing. For example, a user may need to enter the vehicle to set-up new pick-up location, in such manner a user may need to take a break from the fitness activity. A user may sit in the vehicle whereupon one or more sensors associated with the vehicle (in combination with UE 101 sensors) may detect health condition of the user. The sensors may perform certain checks and may alert the user before the user continues with his/her training activity. For example, one or more sensors may detect that a user is dehydrated, whereupon the autonomous vehicle may recommend a user to drink water before continuing with his/her training activity.

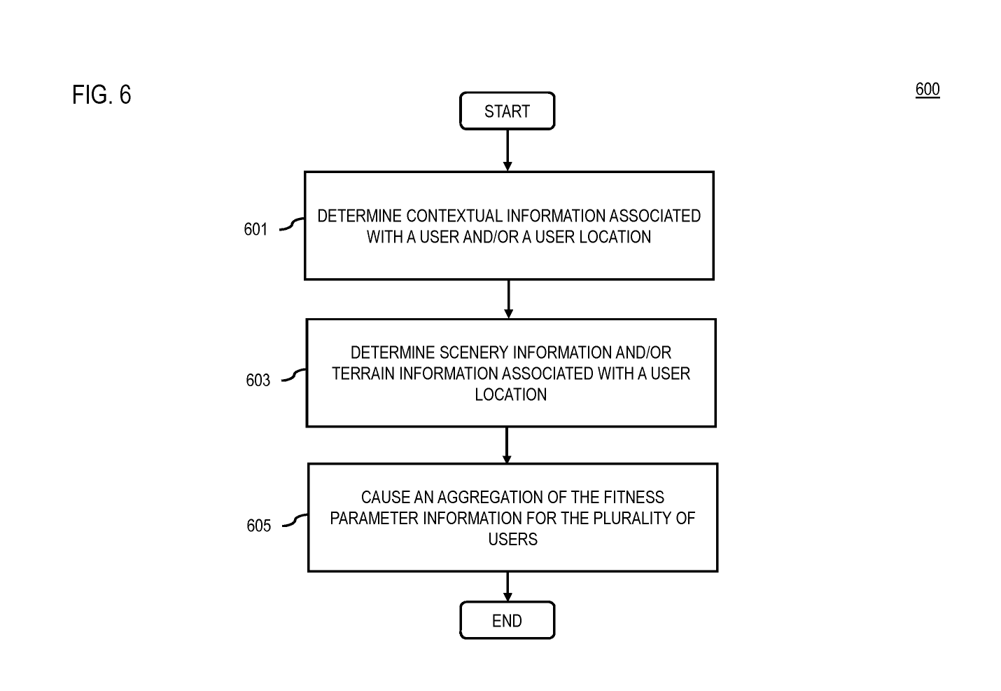

FIG. 6 is a flowchart of a process for determining contextual information associated with one or more users, and the nearby environment associated with the user location, according to one embodiment. In one embodiment, the configuration platform 109 performs the process 600 and is implemented in, for instance, a chip set including a processor and a memory as shown in FIG. 11.

In step 601, the configuration platform 109 may determine a contextual information associated with the at least one user, the at least one user location, or a combination thereof. In one embodiment, the calculation of the at least one at least one drop-off location, the at least one pick-up location, or a combination thereof is further based, at least in part, on the contextual information. In one scenario, the contextual information includes weather information, calendar information, traffic information, information on whether a user is carrying a load etc. In another scenario, the configuration platform 109 may determine a pick-up location depending upon the context of a user, for example, a user may want to walk and not run because the user does not want to sweat. In accordance, the configuration platform 109 may set a timing for pick-up at a convenient location.

In step 603, the configuration platform 109 may determine scenery information, terrain information, public safety information, temporal information, or a combination thereof associated with the at least one user location. In one embodiment, the calculation of the at least one at least one drop-off location, the at least one pick-up location, or a combination thereof is further based, at least in part, on the scenery information, the terrain information, public safety information, temporal information, or a combination thereof. In one scenario, the configuration platform 109 may adjust the fitness activity based on the available terrain close to the selected route/trip and time, i.e., if less time is available then training route/area may have more elevation changes. In another scenario, if a user is walking to a pick-up location, the pedestrian route may be optimized so that the user walks through a park or nearby interesting landmarks. In a further scenario, the configuration platform 109 may not recommend a drop-off location and/or a pick-up location that is not safe during late or early hours of the day, or has a high crime rates. In one scenario, passenger routes may be optimized based on public transit lines. This process may involve a user walking between certain stations rather than using the transit in-between.

In step 605, the configuration platform 109 may cause an aggregation of the fitness parameter information for the plurality of users. In one embodiment, the calculation of the at least one at least one drop-off location, the at least one pick-up location, or a combination thereof is further based, at least in part, on the aggregation. In another embodiment, the aggregation is performed based, at least in part, on a weakest one of the plurality of users, a strongest one of the plurality of users, an average of the plurality of users, or a combination thereof. In one scenario, the configuration platform 109 may detection of one or more passengers in at least one vehicle. Then, the configuration platform 109 may cause an optimization of at least one pick-up location, at least one drop-off location, or a combination thereof based, at least in part, on a weighted average of the health condition of one or more passengers. In another scenario, different drop-off location and/or pick-up location may be adjusted based on the potential of the users. In a further scenario, the configuration platform 109 may recommend at least one user to start at a different time to reach the pick-up destination at the same time with other users.

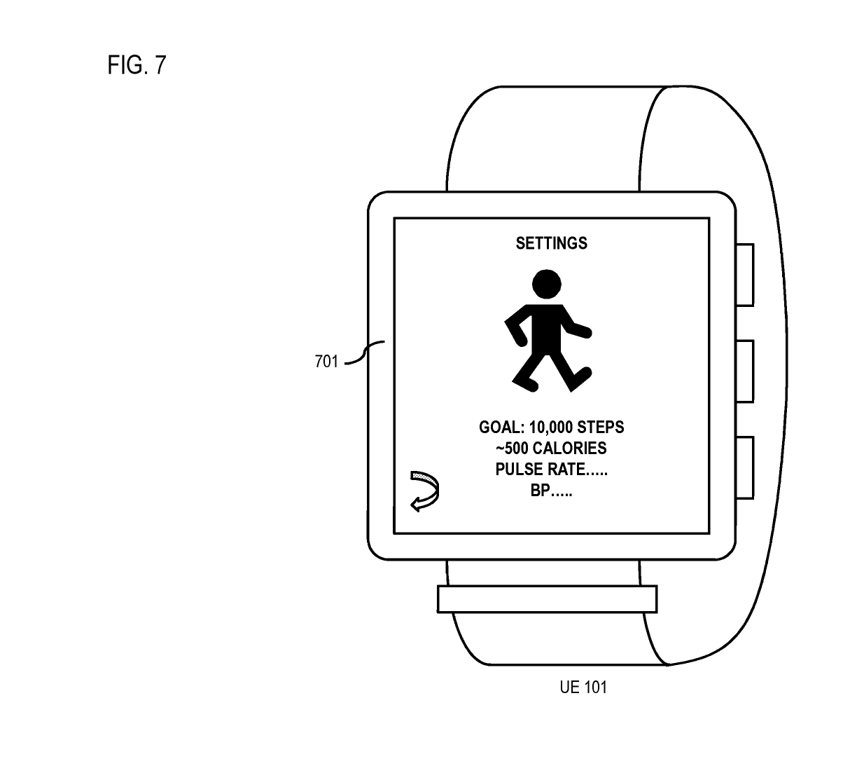

FIG. 7 is a user interface diagram that represents a fitness application that tracks training activity for at least one user, according to one example embodiment. In one scenario, the fitness application may monitor the number of steps taken by a user, the calories burned, pulse rate, blood pressure, etc. [701]. The configuration platform 109 may cause a communication between at least one fitness device associated with at least one user and at least one device associated with at least one vehicle. Then, the configuration platform 109 may cause a transmission of the monitored information to the at least one device associated with at least one vehicle. Subsequently, the configuration platform 109 may cause synchronization of data between at least one fitness device associated with at least one user and at least one device associated with at least one vehicle.

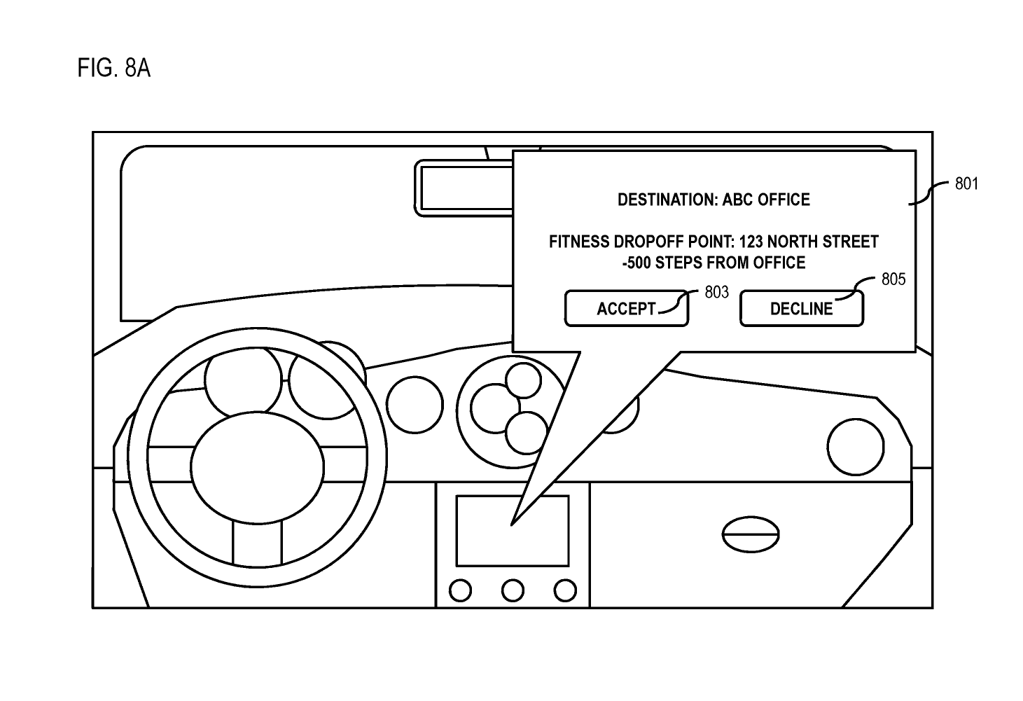

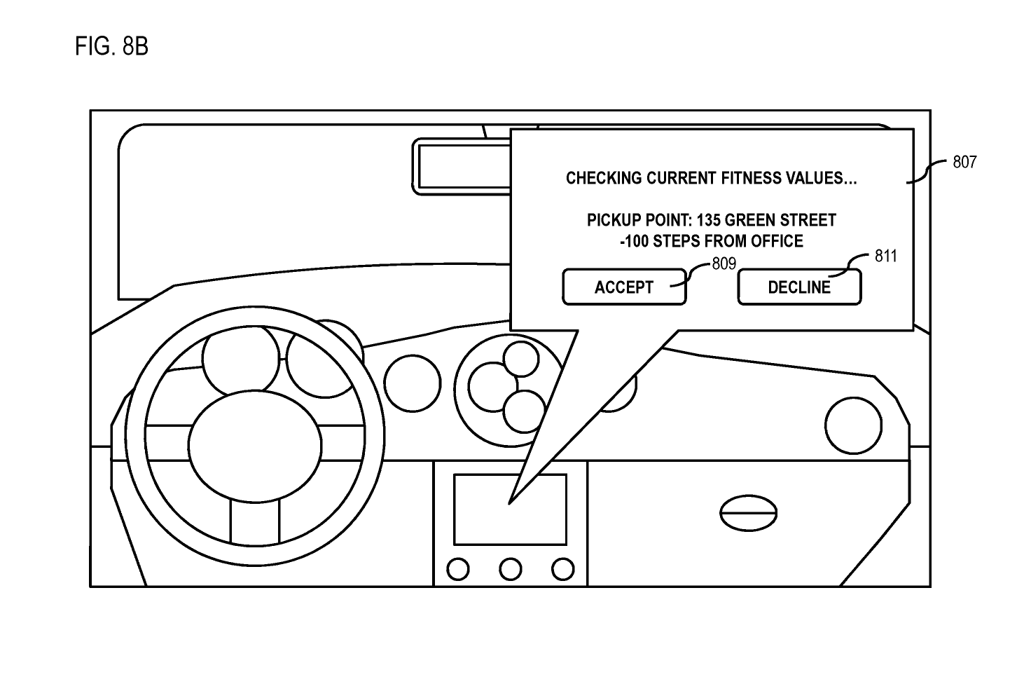

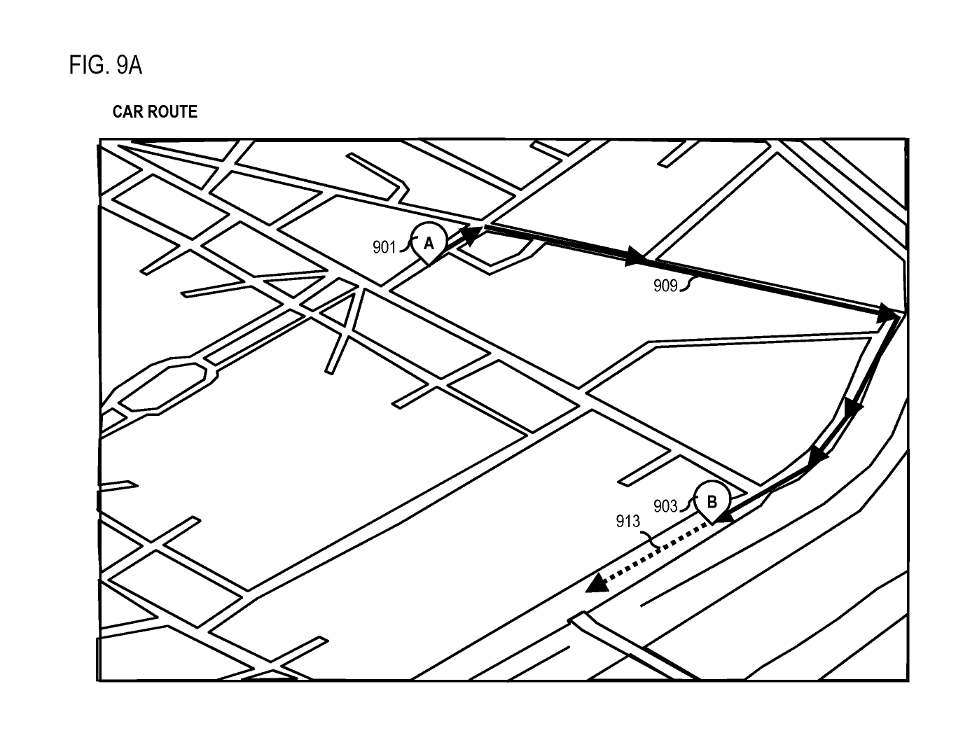

FIG. 8A is a user interface diagram that represents a scenario wherein at least one vehicle recommends at least one drop-off location to at least one user, according to one example embodiment. In one scenario, the configuration platform 109 may cause, at least in part, a processing of the monitored information from at least one fitness device associated with at least one user. Then, the configuration platform 109 may determine at least one drop-off location, timing for a drop-off, or a combination thereof based, at least in part, on the processing of the monitored information. Subsequently, a user is presented with the information on the drop-off location via a device associated with the vehicle which the user may accept [801]. As soon as the user accepts the recommended drop-off location [803], the configuration platform 109 may configure at least one vehicle to travel to the agreed drop-off location. In another scenario, a user may decline [805] a recommended drop-off location, and may set-up a new drop-off location as per his/her preference.

FIG. 8B is a user interface diagram that represents a scenario wherein at least one vehicle recommends at least one pick-up location to at least one user, according to one example embodiment. In one scenario, the configuration platform 109 may check current fitness targets for at least one user to determine their progress towards their fitness goals. Then, the configuration platform 109 may recommend at least one pick-up location based, at least in part, on pre-defined criteria, for example, maximum distance a user can walk. Subsequently, a user is presented with the information on the pick-up location which the user may accept [807]. Once the user accepts the recommended pick-up location [809], the configuration platform 109 configures at least one vehicle to travel to the agreed pick-up location. In another scenario, a user may decline [811] the recommended pick-up location, and may set-up a new pick-up location as per his/her preference. A user may specify one or more areas more suitable for pick-up or drop-off based on personal preferences or other parameters.

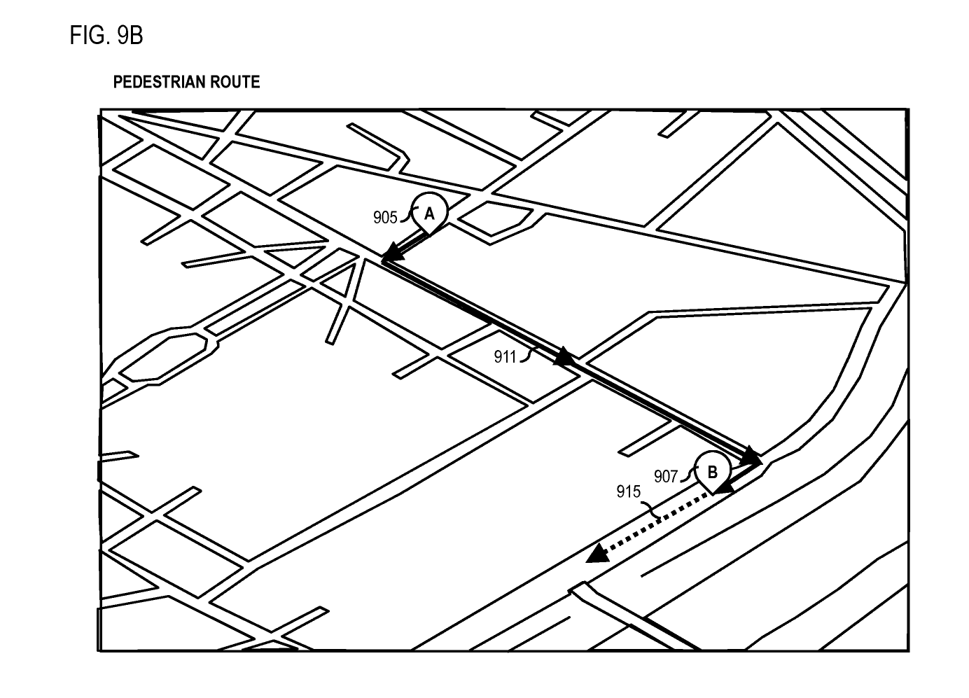

FIG. 9 A-B are user interface diagrams that represents a scenario wherein pedestrian routes are optimized with the vehicle routes to support going faster to the at least one destination, according to one example embodiment. In one scenario, large cities have numerous one-way streets, as a result of which the configuration platform 109 may take advantage of the flexibility of the pedestrian route. The configuration platform 109 may propose a best route by causing a balance between the pedestrian route and the driving route. FIG. 9A represents the route a user would take to reach at least one destination via a vehicle. On the other hand, FIG. 9B represents the route a user would take to reach at least one destination by walking. In one example embodiment, A [901, 905] is the user's current location, and B [903, 907] is the proposed pick-up location so that a user walks a bit and also saves time as it would otherwise be a long detour. In one scenario, such map representation may recommend a user to walk because the pedestrian route is shorter compared to the driving route [909, 911]. This method is good for user's fitness and saves time in reaching a destination. In one scenario, the dotted lines may represent the path to a user's home afterwards [913, 915]. In another scenario, the configuration platform 109 may propose a departure time for at least one user based, at least in part, on planned arrival time. The configuration platform 109 may take into consideration the traffic on the route, and may also adapt a route upon realizing that a user is willing to walk. Further, the configuration platform 109 may recommend a longer uninterrupted walks for one or more users given that such activity is beneficial for burning more calories.

The processes described herein for determining a drop-off location, a pick-up location, or a combination thereof at a certain time period based, at least in part, on user fitness targets, user preferences, or a combination thereof may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

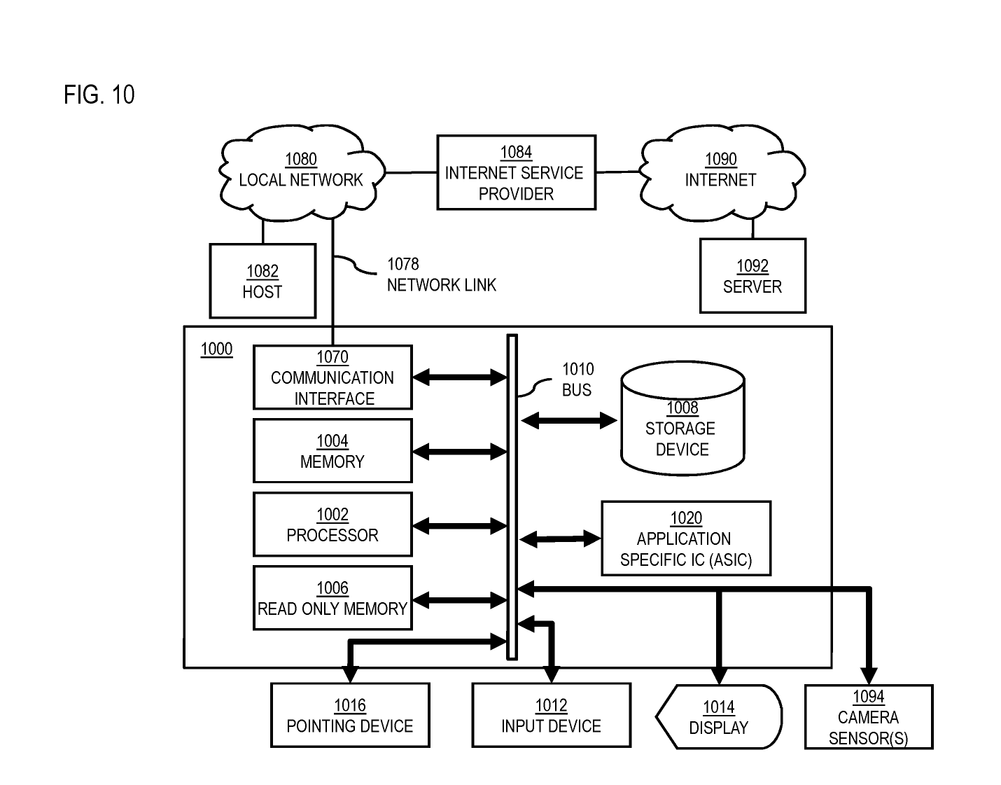

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to determine a drop-off location, a pick-up location, or a combination thereof at a certain time period based, at least in part, on user fitness targets, user preferences, or a combination thereof as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of determining a drop-off location, a pick-up location, or a combination thereof at a certain time period based, at least in part, on user fitness targets, user preferences, or a combination thereof.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related to determine a drop-off location, a pick-up location, or a combination thereof at a certain time period based, at least in part, on user fitness targets, user preferences, or a combination thereof. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1000 also includes a memory 1004 coupled to bus 1010. The memory 1004, such as a random access memory (RAM) or any other dynamic storage device, stores information including processor instructions for determining a drop-off location, a pick-up location, or a combination thereof at a certain time period based, at least in part, on user fitness targets, user preferences, or a combination thereof. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or any other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for determining a drop-off location, a pick-up location, or a combination thereof at a certain time period based, at least in part, on user fitness targets, user preferences, or a combination thereof, is provided to the bus 1010 for use by the processor from an external input device 1012, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT), a liquid crystal display (LCD), a light emitting diode (LED) display, an organic LED (OLED) display, a plasma screen, or a printer for presenting text or images, and a pointing device 1016, such as a mouse, a trackball, cursor direction keys, or a motion sensor, for controlling a position of a small cursor image presented on the display 1014 and issuing commands associated with graphical elements presented on the display 1014, and one or more camera sensors 1094 for capturing, recording and causing to store one or more still and/or moving images (e.g., videos, movies, etc.) which also may comprise audio recordings. In some embodiments, for example, in embodiments in which the computer system 1000 performs all functions automatically without human input, one or more of external input device 1012, display device 1014 and pointing device 1016 may be omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of ASICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 107 for determining a drop-off location, a pick-up location, or a combination thereof at a certain time period based, at least in part, on user fitness targets, user preferences, or a combination thereof to the UE 101.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or any other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set or chip 1100 upon which an embodiment of the invention may be implemented. Chip set 1100 is programmed to determine a drop-off location, a pick-up location, or a combination thereof at a certain time period based, at least in part, on user fitness targets, user preferences, or a combination thereof as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of functions. Chip set or chip 1100, or a portion thereof, constitutes a means for performing one or more steps of determining a drop-off location, a pick-up location, or a combination thereof at a certain time period based, at least in part, on user fitness targets, user preferences, or a combination thereof.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to determine a drop-off location, a pick-up location, or a combination thereof at a certain time period based, at least in part, on user fitness targets, user preferences, or a combination thereof. The memory 1105 also stores the data associated with or generated by the execution of the inventive steps.

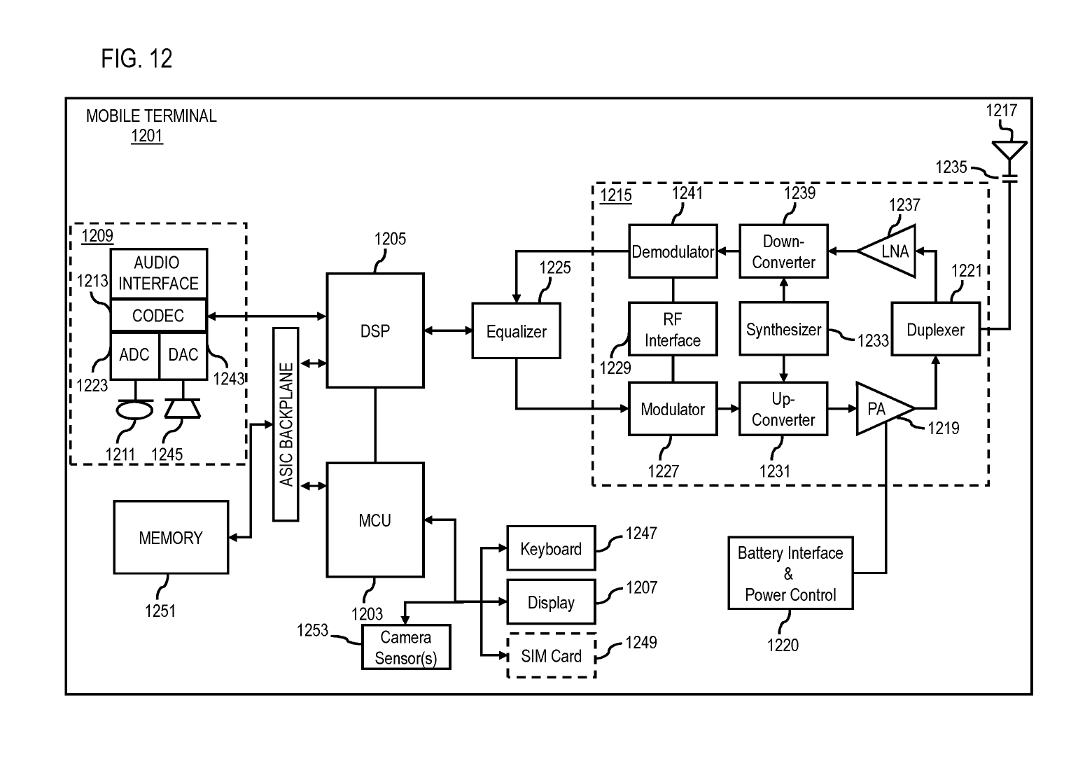

FIG. 12 is a diagram of exemplary components of a mobile terminal (e.g., handset) for communications, which is capable of operating in the system of FIG. 1, according to one embodiment. In some embodiments, mobile terminal 1201, or a portion thereof, constitutes a means for performing one or more steps of determining a drop-off location, a pick-up location, or a combination thereof at a certain time period based, at least in part, on user fitness targets, user preferences, or a combination thereof. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of determining a drop-off location, a pick-up location, or a combination thereof at a certain time period based, at least in part, on user fitness targets, user preferences, or a combination thereof. The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203 which can be implemented as a Central Processing Unit (CPU).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 to determine a drop-off location, a pick-up location, or a combination thereof at a certain time period based, at least in part, on user fitness targets, user preferences, or a combination thereof. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

Further, one or more camera sensors 1253 may be incorporated onto the mobile station 1201 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
determining at least one user location associated with at least one user;
determining fitness parameter information associated with the at least one user;
causing, at least in part, a calculation of at least one drop-off location, at least one pick-up location, or a combination thereof with respect to the at least one user location based, at least in part, on the fitness parameter information; and
causing, at least in part, a configuration of at least one vehicle to travel to the at least one drop-off location, at least one pick-up location, or a combination thereof.

2. A method of claim 1, wherein the at least one vehicle is an autonomous vehicle, and wherein the at least one user location includes, at least in part, at least one current location, at least one destination location, or a combination thereof.

3. A method of claim 1, further comprising:
causing, at least in part, a monitoring of health sensor information, fitness performance information, or a combination thereof associated with the at least one user during travel by the at least one user from the at least one user location to the at least one drop-off location, the at least one pick-up location, or a combination thereof;
causing, at least in part, a recalculation of the at least one drop-off location, the at least one pick-up location, or a combination thereof based, at least in part, on the monitoring of the health sensor information; and
causing, at least in part, a synchronization of the recalculation of the at least one drop-off location, the at least one pick-up location, or a combination thereof to the at least one vehicle.

4. A method of claim 3, further comprising:
processing and/or facilitating a processing of the health sensor information to determine at least one health condition associated with the at least one user; and
causing at least one of:
an override of the at least one drop-off location, the at least one pick-up location, or a combination thereof;
a presentation of at least one alert message regarding the at least one health condition;
a directing of the at least one vehicle to at least one current location of the at least one user to collect additional sensor information, to deliver one or more supplies, to request user interaction with the at least one vehicle, or a combination thereof; and
a collection of additional health sensor information by one or more sensors of the at least one vehicle.

5. A method of claim 1, further comprising:
processing and/or facilitating a processing of the fitness parameter information to recommend at least one fitness activity for the user to engage in during travel between the at least one user location and the at least one drop-off location, the at least one pick-up location, or a combination thereof.

6. A method of claim 5, wherein the at least one fitness activity includes, at least in part, a walking activity, a running activity, a bicycling activity, a swimming activity, or a combination thereof.

7. A method of claim 1, further comprising:
determining contextual information associated with the at least one user, the at least one user location, or a combination thereof,
wherein the calculation of the at least one at least one drop-off location, the at least one pick-up location, or a combination thereof is further based, at least in part, on the contextual information.

8. A method of claim 7, further comprising:
determining scenery information, terrain information, or a combination thereof associated with the at least one user location,
wherein the calculation of the at least one at least one drop-off location, the at least one pick-up location, or a combination thereof is further based, at least in part, on the scenery information, the terrain information, or a combination thereof.

9. A method of claim 1, wherein the at least one user includes a plurality of users, the method further comprising:
causing, at least in part, an aggregation of the fitness parameter information for the plurality of users,
wherein the calculation of the at least one at least one drop-off location, the at least one pick-up location, or a combination thereof is further based, at least in part, on the aggregation; and
wherein the aggregation is performed based, at least in part, on a weakest one of the plurality of users, a strongest one of the plurality of users, an average of the plurality of users, or a combination thereof.

10. An apparatus comprising:
at least one processor; and
at least one memory including computer program code for one or more programs,
the at least one memory and the computer program code configured to, with the at least one processor, cause the apparatus to perform at least the following,
determine at least one user location associated with at least one user;
determine fitness parameter information associated with the at least one user;
cause, at least in part, a calculation of at least one drop-off location, at least one pick-up location, or a combination thereof with respect to the at least one user location based, at least in part, on the fitness parameter information; and
cause, at least in part, a configuration of at least one vehicle to travel to the at least one drop-off location, at least one pick-up location, or a combination thereof.

11. An apparatus of claim 10, wherein the at least one vehicle is an autonomous vehicle, and wherein the at least one user location includes, at least in part, at least one current location, at least one destination location, or a combination thereof.

12. An apparatus of claim 10, wherein the apparatus is further caused to:
cause, at least in part, a monitoring of health sensor information, fitness performance information, or a combination thereof associated with the at least one user during travel by the at least one user from the at least one user location to the at least one drop-off location, the at least one pick-up location, or a combination thereof;
cause, at least in part, a recalculation of the at least one drop-off location, the at least one pick-up location, or a combination thereof based, at least in part, on the monitoring of the health sensor information; and
cause, at least in part, a synchronization of the recalculation of the at least one drop-off location, the at least one pick-up location, or a combination thereof to the at least one vehicle.

13. An apparatus of claim 12, wherein the apparatus is further caused to:
process and/or facilitate a processing of the health sensor information to determine at least one health condition associated with the at least one user; and
cause at least one of:
an override of the at least one drop-off location, the at least one pick-up location, or a combination thereof;
a presentation of at least one alert message regarding the at least one health condition;
a directing of the at least one vehicle to at least one current location of the at least one user to collect additional sensor information, to deliver one or more supplies, to request user interaction with the at least one vehicle, or a combination thereof and
a collection of additional health sensor information by one or more sensors of the at least one vehicle.

14. An apparatus of claim 10, wherein the apparatus is further caused to:
process and/or facilitate a processing of the fitness parameter information to recommend at least one fitness activity for the user to engage in during travel between the at least one user location and the at least one drop-off location, the at least one pick-up location, or a combination thereof.

15. An apparatus of claim 14, wherein the at least one fitness activity includes, at least in part, a walking activity, a running activity, a bicycling activity, a swimming activity, or a combination thereof.

16. An apparatus of claim 10, wherein the apparatus is further caused to:
determine contextual information associated with the at least one user, the at least one user location, or a combination thereof,
wherein the calculation of the at least one at least one drop-off location, the at least one pick-up location, or a combination thereof is further based, at least in part, on the contextual information.

17. An apparatus of claim 16, wherein the apparatus is further caused to:
determine scenery information, terrain information, or a combination thereof associated with the at least one user location,
wherein the calculation of the at least one at least one drop-off location, the at least one pick-up location, or a combination thereof is further based, at least in part, on the scenery information, the terrain information, or a combination thereof.

18. A computer-readable storage medium carrying one or more sequences of one or more instructions which, when executed by one or more processors, cause an apparatus to at least perform the following steps:
determine at least one user location associated with at least one user;
determine fitness parameter information associated with the at least one user;
cause, at least in part, a calculation of at least one drop-off location, at least one pick-up location, or a combination thereof with respect to the at least one user location based, at least in part, on the fitness parameter information; and
cause, at least in part, a configuration of at least one vehicle to travel to the at least one drop-off location, at least one pick-up location, or a combination thereof.

19. A computer-readable storage medium of claim 18, wherein the at least one vehicle is an autonomous vehicle, and wherein the at least one user location includes, at least in part, at least one current location, at least one destination location, or a combination thereof.

20. A computer-readable storage medium of claim 18, wherein the apparatus is further caused to:
cause, at least in part, a monitoring of health sensor information, fitness performance information, or a combination thereof associated with the at least one user during travel by the at least one user from the at least one user location to the at least one drop-off location, the at least one pick-up location, or a combination thereof;
cause, at least in part, a recalculation of the at least one drop-off location, the at least one pick-up location, or a combination thereof based, at least in part, on the monitoring of the health sensor information; and
cause, at least in part, a synchronization of the recalculation of the at least one drop-off location, the at least one pick-up location, or a combination thereof to the at least one vehicle.

21.-46. (canceled)
